(19) United States
(12) Patent Application Publication
(10) Pub. No.: US 2010/0149931 A1
(43) Pub. Date: Jun. 17, 2010

(54) SMART STEERING FOR FOUR WIRE THREE-DIMENSIONAL (3D) ACTUATOR

(75) Inventors: Michel Albertus Theodorus Klein Swormink, Eindhoven (NL); Joop Van Bijnen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,255

(22) PCT Filed: Jun. 22, 2006
(86) PCT No.: PCT/IB06/52025

§ 371 Date: Dec. 20, 2007

(30) Foreign Application Priority Data
Jun. 28, 2005 (EP) 05105745.3

(51) Int. Cl. G11B 7/00; G11B 19/00

(52) U.S. Cl. 369/44.11; 369/47.5; G9B/7

(57) ABSTRACT

An actuator system for use in an optical pick up unit is disclosed. The system comprises a plurality of actuator drivers (301, 305, 309), each actuator driver being connected to a first end of a separate actuator coil (313, 315, 317), wherein a second end of each actuator coil is tied together to form a common end, said actuator drivers each being connected to a supply voltage Vcc and ground. A variable voltage supply (319) is connected to the common end of the actuator coils for varying the voltage applied to the common end of the actuator coils. A feed-back unit (303, 307, 311) is connected to each of the plurality of actuator drivers, wherein each of the feedback units measures the current voltage being supplied to the second ends of the actuator coils and compensates the voltage applied to the first end of the actuator coil by the actuator driver.

This invention pertains in general to the field of optical disc players. More particularly the invention relates to actuator steering in the optical disc player and more particularly to increasing the dynamic voltage swing on a four wire 3D actuator.

Different formats of optical recording medium including read-only optical discs, such as CD (Compact Disk), and DVD (Digital Versatile Disc); and recordable optical discs such as a CD-R (Compact Disc-Recordable), CD-RW (Compact Disc-Rewritable) and DVD+RW (Digital Versatile Disc+Rewritable) are well known. These optical recording medium media may be written and/or read out by means of an optical pick up unit or a read head in an optical scanning device. The optical pick up units are mounted on a linear bearing for radially scanning across the tracks of the optical disc. The read head may comprise, among other elements, an actuator for focus, radial and tilt.

The optical scanning device comprises a light source such as a laser which is directed toward the optical disc. In addition to detecting and reading the information from the optical disc, the optical pick up unit also detects a variety of error signals, e.g., focus error, radial error and tracking error. These error signals are used by the optical scanning device to adjust various aspects of the scanning procedure to help reduce these errors. For example, the focus error signal can be used to determine how much the focus actuator should be steered to improve the focus of the laser.

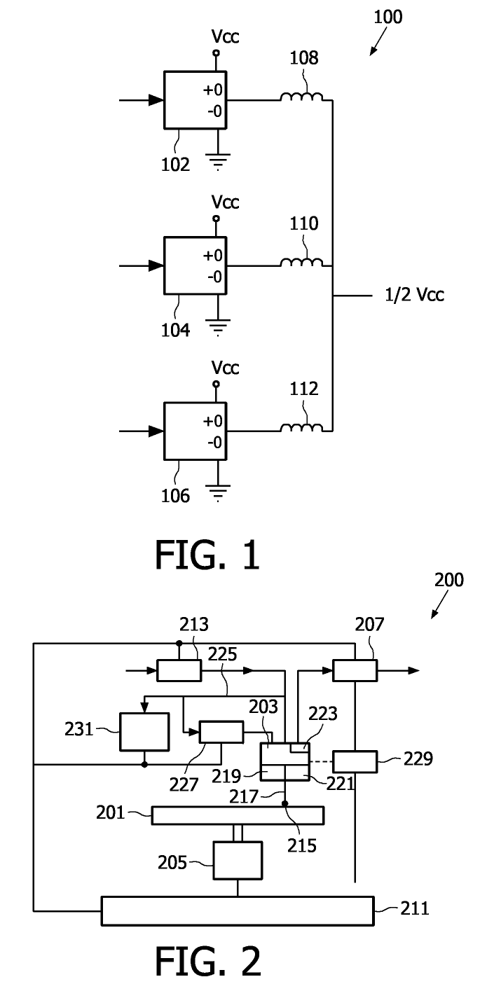

The actuators in the read head are typically implemented as a four wire three-dimensional (3D) actuator or a six wire 3D actuator. A four wire 3D actuator 100 is disclosed in FIG. 1. The actuator 100 comprises a tilt coil 102, a focus coil 104 and a radial coil 106.

Tilt function can also be achieved by a combination of two focus coils or two radial coils, in which case you still need 3 coils. Each actuator coil is connected to the supply voltage Vcc and ground. Each actuator coil also has a positive output terminal and a negative output terminal. This allows each actuator to drive or move the read head in two directions. In addition, the tilt actuator 102 is connected via either the positive and negative terminals to a first end of a coil 108, the focusing actuator 104 is connected via either the positive and negative terminals to a first end of a coil 110, and the radial actuator coil 106 is connected via either the positive and negative terminals to a first end of a coil 112. The second end of the coils 108, 110, 112 are connected together and tied to ½ Vcc.

In operation, each actuator 102, 104, 106 can drive the read head in one of two directions depending upon whether the positive or negative terminals in each actuator are connected to their respective coils 108, 110, 112. The voltage swing which can be used on the coils is however limited to ½ Vcc. This means that acceleration and deceleration of the read head by the actuator is limited to that produced when ½ Vcc is applied. One way to overcome this problem is to lower the resistance in the coils but this causes various problems in the manufacture and life expectancy of the coils. In practice, this means that the speed is limited on high unbalance discs by the actuator/driver voltage swing. The limited voltage swing has the most negative effect on radial actuator when performing a disc jump or layer jump.

Thus, there is a need for an advantageous method and apparatus, which for instance increases the dynamic voltage swing on a four wire 3D actuator without lose of performance in an optical pick up unit.

Accordingly, the present invention preferably seeks to mitigate, alleviate or eliminate one or more of the above-identified deficiencies in the art and disadvantages singly or in any combination and solves at least the above mentioned problems, at least partly, by providing a system, a method, and a computer-readable medium, which increase a dynamic voltage swing in an actuator according to the appended patent claims. The invention is based on the insight to vary the voltage applied to a common end of a plurality of actuator coils while compensating the signals applied to the other ends of the actuator coils from the plurality of actuator drivers.

According to one aspect of the invention, an actuator system is disclosed, wherein the actuator system comprises: a plurality of actuator drivers, each actuator driver being connected to a first end of a separate actuator coil, wherein a second end of each actuator coil are tied together to form a common end, said actuator drivers each being connected to Vcc and ground; a variable voltage supply which is connected to the common end of the actuator coils for varying the voltage applied to the common end of the coils; and a feedback unit connected to each of the plurality of actuator drivers, wherein each of said feedback units measures the current voltage being supplied to the second ends of the actuator coils and compensates the voltage applied to the first end of the actuator coil by the actuator driver.

According to one aspect of the invention, a method is provided for increasing a dynamic voltage swing on an actuator system, said system comprising a plurality of actuator drivers, each actuator driver being connected to a first end of a separate actuator coil, wherein a second end of each actuator coil are tied together to form a common end, a variable voltage supply which is connected to the common end of the actuator coils, and a feedback unit connected to each of the plurality of actuator drivers, said method comprising the steps of adjusting the voltage supplied to the second ends of the actuator coils by the variable voltage supply; and compensating an input signal to each actuator coil depending on the voltage being supplied to the second ends of the actuator coils.

According to a further aspect of the invention, a computer-readable medium having embodied thereon a computer program for increasing a dynamic voltage swing on an actuator system, for processing by a computer is provided. The computer program comprises a code segment for adjusting the voltage supplied to a second end of each of a plurality of actuator coils by the variable voltage supply, said second end of each actuator coil being connected together; and a code segment for compensating an input signal to each actuator coil depending on the voltage being supplied to the second ends of the actuator coils.

The present invention has at least the advantage over the prior art that it increases the dynamic voltage swing on an actuator without lose of performance.

These and other aspects, features and advantages of which the invention is capable of will be apparent and elucidated from the following description of embodiments of the present invention, reference being made to the accompanying drawings, in which

FIG. 1 is a block diagram of a known four wire 3D actuator and actuator driver;

FIG. 2 is a block diagram of an optical system upon which the invention may be implemented;

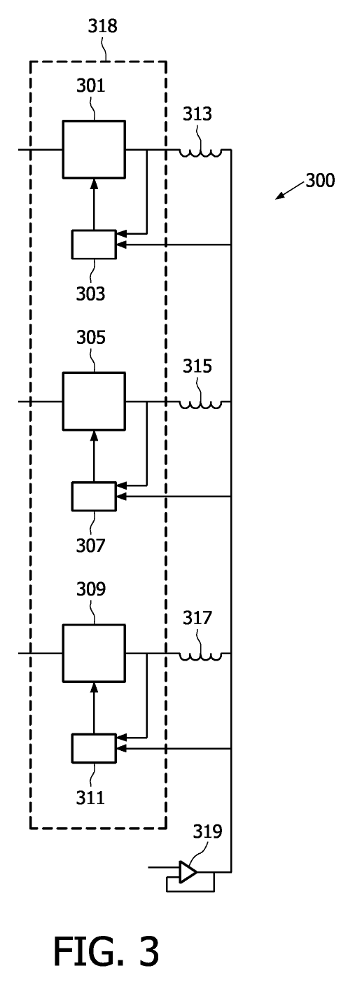

FIG. 3 is a block diagram of a four wire 3D actuator and actuator driver according to one embodiment of the invention; and

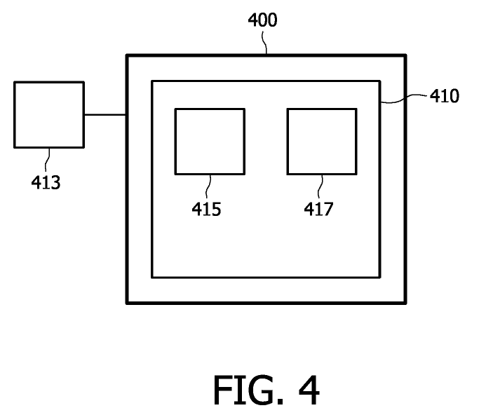

FIG. 4 is a computer readable medium according to one embodiment of the invention.

The following description focuses on an embodiment of the present invention applicable to a steering actuator and in particular to a four wire 3D actuator for use in an optical pick up unit of a disc player. However, it will be appreciated that the invention is not limited to this application but may be applied to many other situations, e.g. for different storage media than a disc.

FIG. 2 illustrates an optical reading/writing system upon which the invention may be implemented. The optical system 200 is arranged to read/write information to or from a disc 201. The system 200 is provided with a read head 203 for scanning the track on the disc 201 and read control means comprising drive means 205 for rotating the disc 201, a reading unit 207 for example comprising a channel decoder and an error corrector, tracking means 227 and a system control unit 211. The read head is also connected to a writing unit 213. The read head comprises an optical system of a known type for generating a radiation spot 215 focused on a track of the recording layer of the disc 201 via a radiation beam 217 guided through optical elements. The radiation beam 217 is generated by a radiation source, e.g. a laser diode. The reading head further comprises an actuator 218 which comprises a focusing actuator coil 219 for focusing the radiation beam 217 on the disc 201 and a radial actuator coil 221 for fine positioning of the spot 215 in radial direction on the center of the track. A tilt actuator coil 223 may be used to change the angle of a reflecting element on a moveable part of the read head 203 or on a part on a fixed position in the case part of the optical system is mounted on a fixed position. The radiation reflected by the recording layer is detected by a detector of a usual type for generating detector signal 225 including a read signal, a tracking error and a focus error. The apparatus 200 is provided with tracking means 227 coupled to the read head 203 for receiving the tracking error and controlling the radial and tilt actuators. During reading, the read signal is converted into output information in the reading unit 207. The apparatus 200 is provided with a header detector 231 for detecting the header areas of the tracks of the disc. The apparatus 200 has positioning means 229 for coarsely positioning the read head 203. Finally, the apparatus is further provided with a system control unit 211 for receiving commands from a controlling computer system or from a user and controlling the operation of the apparatus 200 via a system bus 233.

FIG. 3 illustrates an actuation system 300 according to one embodiment of the invention. The actuation system 300 comprises an actuator 318 which comprises a tilt actuator driver 301, a focus actuator driver 305 and a radial actuator driver 309. Each actuator driver is connected to the supply voltage Vcc and ground. Each actuator driver also has a positive output terminal and a negative output terminal. This allows each actuator driver to drive or move the read head in two directions. In addition, the tilt actuator driver 301 is connected via either the positive and negative terminals to a first end of an actuator coil 313, the focusing actuator driver 305 is connected via either the positive and negative terminals to a first end of an actuator coil 315, and the radial actuator driver 309 is connected via either the positive and negative terminals to a first end of an actuator coil 317. The second end of the coils 313, 315, 317 are connected together and tied to a variable voltage supply 319. In this illustrative embodiment, the common voltage is applied to an amplifier so that the voltage applied to the common ends of the coils may vary from 0 to Vcc. In this example, if Vcc is 12V, the voltage may vary from 0 to 12V. It is however important to remember that the total available voltage for both the positive swing and the negative swing is Vcc (12V). So for example, if a common voltage for the positive voltage swing is 8V then only 4V is available for the negative swing.

When the common voltage is changed, the coil input from the actuator needs to be compensated. In FIG. 3, each actuator 301, 305, 309 has a feedback compensation unit 303, 307 and 311, respectively. The feedback compensation units compare the voltage across the coil and send a compensation signal to the actuator driver which compensates the input signal to the actuator coils so that the proper voltage is applied to the coil input. The signal at the output of the actuator drivers 301, 305 and 309 is compared with the signal that is measured over the actuator coils 313, 315 and 317 by unit 303, 307 and 311. The measured error is used as compensation signal that is fed back to the actuator drivers 301,305 and 309, thus compensating for the voltage change on the common ends of the actuator coils. It will be understood by those skilled in the art that the described feedback compensation may be performed using hardware and/or software, and the invention is not limited to a single implementation.

By making the common voltage adjustable by connecting it to the amplifier, the actuator system can enjoy the benefits produced by the greater voltage swing over the coils. The higher voltage swing allows for higher actuator accelerations and decelerations, this results in improved playability for a larger range of discs and decreases RVO problems. In short, this improves TrackLoss Less Servo (TLLS). This also results in less clipping against Vcc.

In another embodiment of the invention according to FIG. 4, a computer-readable medium is illustrated schematically. A computer-readable medium 400 has embodied thereon a computer program 410 for processing by a computer 413, the computer program comprising code segments for increasing a dynamic voltage swing in an actuator system. The computer program comprises a code segment 415 for adjusting the voltage supplied to the second ends of the actuator coils by the variable voltage supply, said second end of each actuator coil being connected together; a code segment 417 for compensating an input signal to each actuator coil depending on the voltage being supplied to the second ends of the actuator coils.

The invention may be implemented in any suitable form including hardware, software, firmware or any combination of these. The invention may be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different systems than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. An actuator system for use in an optical pick up unit, comprising:
a plurality of actuator drivers (301, 305, 307), each actuator driver being connected to a first end of a separate actuator coil (313, 315, 317), wherein a second end of each actuator coil is tied together to form a common end, said actuator drivers each being connected to a supply voltage (Vcc) and ground;
a variable voltage supply (319) which is connected to the common end of the actuator coils for varying the voltage applied to the common end of the actuator coils;
a feedback unit (303, 307, 311) connected to each of the plurality of actuator drivers, wherein each of said feedback units of said system is configured to, in use of said system, measure the current voltage being supplied to the second ends of the actuator coils and to compensate the voltage applied to the first end of the actuator coil by the actuator driver.

2. The system according to claim 1, wherein the variable voltage supply (319) is an amplifier which is connected to Vcc.

3. The system according to claim 2, wherein the amplifier is configured to apply a voltage up to Vcc to the common end of the actuator coils (313, 315, 317).

4. The system according to claim 1, wherein a voltage swing of up to Vcc is available on the actuator coils (313, 315, 317).

5. The system according to claim 4, wherein said voltage swing allows higher actuator accelerations and decelerations.

6. The system according to claim 1, wherein said plurality of actuator coils equals three actuator coils (313, 315, 317).

7. The system according to claim 6, wherein said three actuator coils are a tilt actuator coil (313), a focus actuator coil (315) and a radial actuator coil (317).

8. A method for increasing a dynamic voltage swing on an actuator system, said system comprising a plurality of actuator drivers, each actuator driver being connected to a first end of a separate actuator coil, wherein a second end of each actuator coil is tied together to form a common end, a variable voltage supply which is connected to the common end of the actuator coils, and a feedback unit connected to each of the plurality of actuator drivers, said method comprising:
adjusting the voltage supplied to the second ends of the actuator coils by the variable voltage supply;
compensating an input signal to each actuator coil depending on the voltage being supplied to the second ends of the actuator coils.

9. A computer-readable medium having embodied thereon a computer program for increasing a dynamic voltage swing on an actuator system, for processing by a computer, the computer program comprising:
a first code segment (415) for adjusting the voltage supplied to a second end of each of a plurality of actuator coils by the variable voltage supply, said second end of each actuator coil being connected together;
a second code segment (417) for compensating an input signal to each actuator coil depending on the voltage being supplied to the second ends of the actuator coils.

10. An apparatus for reading and/or writing information to a recording medium, comprising the actuator system as claimed in claim 1.
